(19) United States
(12) Patent Application Publication
(10) Pub. No.: US 2005/0058875 A1
(43) Pub. Date: Mar. 17, 2005

(54) Mixed reactant molecular screen fuel cell

(76) Inventor: Allan Jerome, Novi, MI (US)

Correspondence Address: Jonathan F. Yates;Liell & McNeil Attorneys PC, P.O. Box 2417, Bloomington, IN, 47402, US

(21) Appl. No.: 10/909,275

(22) Filed: Jul. 30, 2004

Related U.S. Application Data
(60) Provisional application No. 60/491,413, filed on Jul. 30, 2003.
(60) Provisional application No. 60/524,475, filed on Nov. 24, 2003.

(51) Int. Cl. H01M 8/02

(52) U.S. Cl. 429/34; 429/13

(57) ABSTRACT

In one aspect, the present invention provides a fuel cell having a first membrane selective to a fuel, a second membrane selective to an oxidant, and a mixed reactant flow provided to the screens. The invention further includes an anode, a cathode and a semi-permeable electrolyte fluidly separating the same.

This application claims the benefit of the filing date of U.S. Provisional Patent Application Ser. No. 60/491,413, filed Jul. 7, 2003, and U.S. Provisional Patent Application Ser. No. 60/524,475, filed Nov. 24, 2003.

### TECHNICAL FIELD

The present invention relates generally to electrochemical fuel cells, batteries and related technologies, and more particularly to an apparatus and process wherein a fuel and oxidant mixture is delivered to separate molecular screens that selectively pass one of the fuel or the oxidant there across for subsequent reaction of the fuel and oxidant and production of an electrical current.

### BACKGROUND OF THE INVENTION

Depletion of naturally occurring petroleum coupled with increasing concern over environmental degradation resulting from the burning of petroleum and coal is driving a search for alternative energy sources. For many years, wind, water and solar power, nuclear power, and other non-petroleum sources have been exploited to address society's demand for cleaner energy. Although these technologies have been successfully exploited in certain environments, they have not proven sufficient to meet the world's ever increasing demands for energy. Moreover, the existing infrastructure for hydrocarbon extraction, fractionation, transport, storage and dispensing imparts a substantial degree of technological inertia, resisting attempts to radically change societal energy sources.

Of particular concern has been the energy needed to power automobiles, heretofore powered almost exclusively by internal petroleum combustion engines. In recent years, energy related developments have focused in significant part on fuel cell technologies. Since fuel cells rely on electrochemistry rather than thermal combustion for useful energy conversion, operating temperatures and conversion efficiencies tend to be relatively high, resulting in relatively low emissions. The current high costs of fuel cells have proven prohibitive to widespread use. Further, production of electricity by combustion remains relatively cheap. Typically, for an internal combustion engine, the power costs approximately $30 to $40 per kW. Although fuel cells offer advantages such as low noise and wide load capability, the major effort in current fuel cell development has been aimed at developing cheaper systems that compete with conventional power-generating systems on the basis of cost, weight and volume.

In one common type of fuel cell oxygen or some other reducible material is passed over one electrode (a cathode) and an oxidizable material such as hydrogen is passed over another electrode (an anode). An “impermeable” electrolyte is positioned between the respective electrodes, and physically separates the reactants. At the anode, hydrogen atoms are split into protons and electrons, typically with the assistance of a catalyst. The protons pass through the electrolyte, which is an ionic conductor that is resistive to the passage of electrons. The electrons tend therefore to follow a path external to the electrolyte, and may be passed through a load to perform work before arriving at the cathode where they combine with oxygen and protons that have migrated through the electrolyte. Oxidation-reduction of the respective materials generates electricity, water and heat. In general, the chemical equation for a typical fuel cell reaction can be represented as follows:
O₂+2H₂_{—}2H₂O+2e⁻

As set forth above, the reaction of one molecule of oxygen with two molecules of hydrogen yields two molecules of water and two free electrons. In this fashion, molecular oxygen and molecular hydrogen are reacted to produce electricity, with water being essentially the sole reaction byproduct. Most proposed designs would require a hydrogen infrastructure to move fuel from one location to another for refueling of fuel cell-driven vehicles and other devices. Hydrogen is relatively expensive to produce, and its storage in significant quantities creates a substantial explosion risk that must be monitored and minimized.

One device used for extracting and collecting hydrogen is known in the art as a “reformer.” Reformers tend to be relatively expensive, bulky and susceptible to various operating and maintenance problems that render them generally unsuitable for small, portable applications. Moreover, while reformers can extract hydrogen from fuel mixtures such as methanol and air, undesirable CO and CO₂ may be produced, and lengthy startup times for fuel cell operation may be necessary in order for the reformer to heat to its desired operating temperature.

The majority of previous work in fuel cell technologies has been based on conventional arrangements such as the system described above, utilizing separate fuel and oxidizer feed systems. Other known designs utilize mixed fuel and oxidizer. In such a design, the mixed reactants flow through a selective cathode, a porous electrolyte, and then through a selective anode.

Although reaction between the mixed components is thermodynamically favorable, significant premature reaction can be suppressed or prevented by several means. For instance, reaction may be effectively prevented by selecting fuel and oxidizer having a relatively high activation energy for the direct reaction, or having relatively slow kinetics for the reaction, or slow diffusion of species. By adopting selectively catalytic electrodes or other selective approaches, a reduction reaction can be promoted at the cathode and an oxidation reaction at the anode. Mixed reactant systems allow complex manifolding required for separate fuel and oxidizer feeds to be eliminated. Accordingly, sealing challenges associated with other, separate reactant designs are reduced or eliminated entirely. Further, the spatial constraints associated with separate reactant designs are overcome. Other advantages of the mixed reactant design include potentially lower cost and increased power density.

Mixed reactant technology has been applied to mixtures generated by radiolytic, electrolytic and photolytic systems. There is thus a considerable degree of flexibility associated with the reactant sources, however, the performance in terms of fuel efficiency and cell voltage (due to parasitic fuel-oxidant reactions) is generally lower than in separate reactant designs. In addition, the fuel/oxidant mixtures can have a tendency to foul the permeable electrolyte.

One example of a mixed reactant system utilizing a flow-through topology is illustrated in WIPO Patent Application Publication No. WO 01/73881 to Priestnall, hereby incorporated by reference. In Priestnall, a fuel cell is provided that includes an anode and cathode and ion-conducting electrolyte means for transporting ions between the electrodes. The electrodes are stated to be porous, with the cell further having means for causing hydrodynamic flow of a mixture of fuel and oxidant through the body of the electrodes. In Priestnall, the incorporation of electrolyte functionality (in the form of a fluid electrolyte or the fuel or oxidant itself) is stated to increase the effective active surface at the electrode. By causing the reactant mixture having triple functionality to pass through the body of a porous electrode, the active surface of the electrode is optimized. Yet another known mixed reactant design is set forth in WIPO Patent Application Publication No. WO 01/73880 also to Priestnall et al., also hereby incorporated by reference.

### SUMMARY OF THE INVENTION

It is an object of the present invention to provide a fuel cell or battery that eliminates the complex manifold and reduces problems associated with stack sealing in a fuel cell.

It is a further object of the present invention to provide a fuel cell or battery that is relatively compact in size having a relatively high power density.

It is a further object of the present invention to provide a fuel cell capable of operation at ambient temperatures.

It is a further object of the present invention to provide a fuel cell or battery capable of using mixed fuel and oxidant as reactants that are readily available from the environment or from radiolytic, electrolytic or photolytic systems.

It is a further object of the present invention to provide a hydrogen based electrical power generating system wherein at least a portion of the original hydrogen source (water) consumed in hydrogen production is reformed and reused.

It is a further object of the present invention to provide a fuel cell that uses low cost non-platinum electrocatalyst thereby replacing expensive platinum electrocatalysts.

It is a further object of the present invention to provide a fuel cell that uses room temperature high proton conductivity proton exchange membranes.

It is a further object of the present invention to provide a fuel cell that uses thin selective fuel and oxidant membranes to substantially increase the power density substantially by replacing thick, bulky, weight heavy bipolar plate and gasketing systemsf.

It is a further object of the present invention to provide a fuel cell that reforms a fuel source such as water into its constituent components oxygen and hydrogen for use as a mixed reactant fuel stream to be fed to a the mixed reactant fuel cell stack.

It is a further object of the present invention to provide a fuel cell onboard on demand regulated hydrogen supply by reforming the fuel source such as water.

In one aspect, the present invention provides a fuel cell having a first membrane selective to a fuel, a second membrane selective to an oxidant, and a mixed reactant flow provided to the screens. The invention further includes an anode, a cathode and a semi-permeable electrolyte fluidly separating the same.

In another aspect, the present invention provides a process of manufacturing a fuel cell that preferably comprises the steps of forming a first molecular screen that is a reductant or fuel screening molecular screen, forming a second molecular screen that is an oxidant screening molecular screen, positioning the first and second molecular screens substantially in parallel and separated by an impermeable electrolyte; and connecting each of the first and second molecular screens with a supply of mixed reductant/fuel and oxidizer, thereby facilitating selective passage of oxidant and reductant/fuel through the first and second molecular screens, respectively.

### DETAILED DESCRIPTION OF PREFERRED EMBODIMENTS

The present invention broadly comprises a fuel cell or battery having a unique topology wherein separate selectively permeable molecular screens are utilized to separate fuel and oxidizer, respectively, from a mixed reactant supply or stream. This unique topology allows a substantially reduced level of hardware, sealing, valving, etc. in a fuel cell, since the oxidizer and fuel can be generated or stored together, and streams of identical fuel mixture delivered to molecular screens for separation into the fuel and oxidizer components. The separated fuel and oxidizer are subsequently recombined under conditions conducive to their chemical reaction. Oxidation of the fuel results in available electrons that can produce an electrical current for performing work in a well known manner.

The components of the mixed reactant stream provided to the fuel cell may be essentially any combination of fuel and oxidizer capable of being separated by any known means. Embodiments are contemplated wherein chemical, physical and catalytic means are used to separate the mixed reactants. The reactant mixture is preferably a gaseous fluid mixture; however, aqueous and non-aqueous liquids, for example oxidant and fuel carriers such as perfluorocarbons, as well as other forms of the reactants are contemplated. Exemplary but not limiting oxidizers include oxygen, hydrogen peroxide, metal salts, etc. Suitable fuels may be essentially any oxidizable material capable of being selectively separated from the reactant mixture. Suitable fuels include hydrogen, hydrocarbons such as methane and propane, alcohols, especially methanol and ethanol, sodium borohydride, ammonia, hydrazine, etc. Environmental gas mixture products such as landfill gas containing air and methane may be utilized in the present invention. Where air is used as the oxidant source, nitrogen (the major constituent of air) can be separated upstream from the fuel cell if desired by any suitable means, including a variety of commercially available nitrogen separation membranes. One preferred nitrogen separation apparatus is a hollow fiber membrane available from Membrane Separation Systems DuPont Air Liquide (MEDAL™).

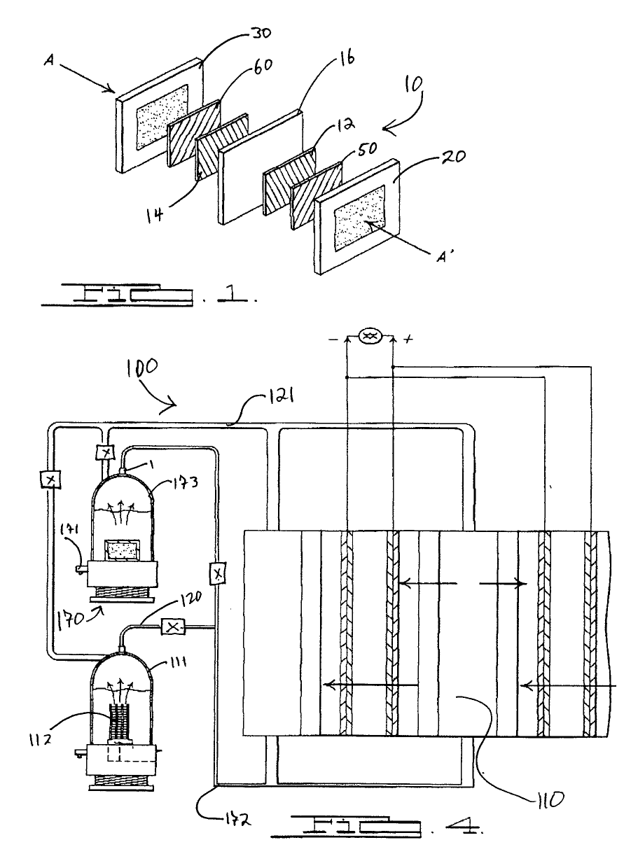

In a preferred constructed embodiment, a first molecular screen is provided that selectively passes oxygen or another suitable oxidizer from the mixed reactant stream, whereas a second molecular screen selectively passes hydrogen or another suitable fuel from the mixed reactant stream. As used herein, the terms “oxygen” and “hydrogen” should be understood to refer generically to oxidizers and fuels, as many alternative mixed reactant systems are contemplated. The oxygen and hydrogen filtered from the reactant streams are reacted, typically with the assistance of a catalyst, to produce water and electricity. Referring first to FIG. 1, there is shown a fuel cell apparatus 10 in accordance with the present invention. Fuel cell 10 preferably includes a first electrode 12 that is a cathode, preferably a selective cathode, and a second electrode 14, preferably a selective anode.

Electrode Construction

Suitable but not limiting materials for the electrodes may be sintered powder, foam, powder compacts, mesh, woven or non-woven materials, perforated sheets, assemblies of tubes or the like, all preferably with deposited electrocatalysts if they are not themselves electrocatalysts. Selective catalysts may be included on the electrodes that preferentially oxidize/reduce either of the fuel or oxidant, depending upon whether the subject electrode is the anode or the cathode. In such a design, catalytic selectivity can be utilized to offset less than perfect selectivity of the molecular screens or to enhance the reduction or oxidation taking place at the respective electrodes.

In a particularly preferred embodiment, an ambient temperature non-platinum cathode is utilized. Such cathodes include those based on pyropolymers, in particular catalysts based on thermally treated macrocyclic metal complexes adsorbed on carbonaceous substrates. Pyropolymeric catalysts are characterized by a high activity, high stability and high selectivity. Suitable non-platinum cathodes are available from Enerl, Inc. of 550 W. Cypress Creek Rd., Ft. Lauderdale, Fla.

Particularly preferred anodes comprise an enzyme electrode having a high specificity for hydrogen, also available from Enerl, of Ft. Lauderdale, Fla. Alternative non-platinum, air electrodes based on charcoal like materials are available from Matsushita Electric Industrial Company of 3-4 Hikaridai, Seika-cho, Sorakugun, Kyoto 619-0237, Japan. Other suitable anode constructions are taught, for instance, a hydrogenase electrocatalyst and anode, in WIPO Patent Application Publication No. WO 03/019705, incorporated by reference herein.

Electrolyte Construction

An “impermeable” electrolyte 16 is preferably sandwiched between the first and second electrodes 12 and 14. In a preferred embodiment, electrolyte 16 is a relatively thin membrane that allows passage of ions such as protons, but is resistive to the passage of electrons. Thus, in operation protons can pass through electrolyte 16 from anode 14 and combine with oxygen and electrons at the cathode 12. The splitting of hydrogen at the anode into protons and electrons is a well known process. Because the electrolyte resists passage of electrons, the electrons stripped from molecular hydrogen will pass through a conductor external to the fuel cell, resulting in an electrical current that can be used to perform useful work, for example, running an electric motor to propel a vehicle or supplying electricity to a home or other building.

The FIG. 1 embodiment preferably includes an oxidant molecular screen 20 and a fuel molecular screen 30. Gas diffusion layers (not shown) are preferably positioned adjacent and inwardly of the oxidant and fuel molecular screens 20 and 30, respectively. Cathode and anode catalyst layers 50 and 60, respectively, are further preferably provided, and are preferably positioned adjacent an impermeable or semi-permeable electrolyte 16. As described above, the terms “impermeable” or “semi-permeable” should be understood to mean a layer that is a relatively good ionic conductor, but a relatively poor electrical conductor. In a preferred embodiment, electrolyte 16 may be formed from a variety of solid or liquid materials, so long as it is sufficiently resistive to electron flow that electrons produced from the splitting of molecular hydrogen at the anode will preferentially flow through an alternate conducting pathway, provided for example through an electrical device, whereas electrolyte 16 is relatively conductive of protons or other fuel ions provided to the cathode. Exemplary materials suitable for a solid form electrolyte include chromate, vanadate, manganate or combinations thereof. Further, sulphonated and/or non-sulphonated polymeric molecular screens, inorganic ionic carriers such as yttria stabilized zirconia, ceria stabilized zirconia, india stabilized zirconia, ceria stabilized gadolinia and silver iodide might be used.

One particularly preferred electrolyte is a relatively new type of proton conducting membrane based on polyvinylidene fluoride derivatives, poly vinyl acetals, sulfonated polystyrene homo- and copolymers. Such membranes are solid polymer membranes and are capable of operating at ambient temperatures. Moreover, the membranes, by virtue of the compositions and casting processes, may be produced as multi-layer membranes having varying properties across the membrane, for example varying hydrophobic properties. Inorganic proton conductors, water absorbents, etc. may be incorporated into the membrane body. These membranes are preferred, among other things, because of their versatility and lower cost compared with conventional perfluorinated polymers containing, for example, —SO₃ functional groups such as are used in Nafion™ type membranes. Suitable membranes are available from Enerl, Inc. of Ft. Lauderdale, Fla.

In FIG. 1, arrows “A” and “A′” represent the direction of reactant mixture flow toward the respective molecular screens 30 and 20. The predominant flow in the presently described arrangement is preferably through the body of the electrodes, as opposed to flow past the surface of the electrodes. This flow is preferably substantially hydrodynamic, meaning that the flow is caused by an external impetus such as an impeller, pump, vacuum pressure, gravity, etc.

Selective Molecular Screen Construction

The selectively permeable molecular screens 20 and 30 may be prepared using any suitable process. Thus, the preferred processes disclosed herein should be understood to be exemplary only, and alternative processes might be used to fabricate suitably selective screens/electrodes without departing from the scope of the present invention.

Diatom-Based Selective Molecular Screens

In one preferred embodiment, the molecular screens are produced by a process that takes advantage of naturally occurring nanopores in diatom skeletons. Diatoms are single celled organisms having silicon and/or calcium skeletons (frustules) that may be used to cast molecular filters formed from a continuous metal film. These metal molecular screens have been shown to be relatively stronger and capable of enduring greater volumetric pressures and greater gas throughputs than other screens or membranes having similar properties. Two main groups of diatoms are well known, and include the pennates which are substantially quill-shaped, and the centrics or Centrales which are substantially cylindrical. Both are available from natural as well as cultured sources.

In a preferred embodiment the process of manufacturing a suitable molecular screen begins with the step of culturing one or more species of diatom having frustules with the appropriate characteristics. Once a sufficient growth of the appropriate diatoms has been achieved, the diatom tissues and frustules are preferably separated, and the frustules embedded in a suitable medium such as paraffin. Next, the embedded frustules are placed on a metal, preferably copper, plate, and a nanoindenter or similar means for manipulating the frustules is used to orient the frustules into a homogeneous layer having the desired geometric pattern. Once the frustules are appropriately arranged, the metal plate is preferably placed in dehydrated ethyl alcohol and an electrically conductive polymer is deposited around the frustules. Suitable processes and compositions for depositing the electrically conductive polymer are set forth in U.S. Pat. Nos. 5,128,013 and 5,186,813, both hereby incorporated by reference. A particularly preferred electroactive polymer composition is disclosed in U.S. Pat. No. 5,328,961 to Rossi et al, also hereby incorporated by reference. Following deposition of the electroactive polymer, the metal plate is next placed in an electrolysis bath to form a metal film around the frustules. After sufficient metal is electroplated thereon, the electrically conductive polymer will be burned away and more metal deposited, resulting in a molecular screen having the desired nanopore structure.

The casting of amorphous silica diatom skeletons, frustules, in a continuous metal film results in thin, strong membranes that can withstand the pressure differentials necessary to achieve larger volumetric gas throughputs than is possible with conventional polymeric membranes. Diatom species preferably used are those having centric skeletons. Suitable living diatom species may be obtained from natural sources or from commercial providers, for example, Reed Mariculture of San Jose, Calif. or from ATCC (American Type Culture Collection; P.O. Box 1549 Manassas, Va., 20108. Culture and nutritional media for growing various selected diatoms may be obtained from ATCC and also, for example, from Argent Labs of Redmond, Wash. Cyclotella, Stephanodiscus and Attheya species of diatoms (family Bacillariophyceae) are exemplary groups suitable for use according to the present invention, although various other species might be used. Separation of the tissues from the silica frustules is a routine procedure known in the life sciences.

The frustule pores are the primary basis for gas selectivity in the membranes and, accordingly, frustule diameter, height, as well as number and diameter of pores in the frustules are all factors bearing on the preferred embodiment. Fracture toughness of the frustules is also important, in that the silica skeletons must be sufficiently tough to withstand the mechanical stresses involved in their physical manipulation and chemical treatment in accordance with the present invention. To determine fracture toughness, for example, a frustule is placed on a stiff plate, then broken by placing the tip of an indenter or similar small manipulating device in one of the pores in the frustule, followed by recording load and displacement of the indenter tip.

A further concern relates to properly orienting and positioning the frustules in the metal film. Maximum gas flows are associated with maximum cross sectional area of frustule pores oriented in the direction of gas flow. Thus, the frustules should be placed as close together as possible without sacrificing too much strength of the membrane, as the closer the frustules are together the less metal deposited there between. In a particularly preferred embodiment, the frustules are placed at nodes of an equilateral triangular grid. Properly positioning the frustules in the desired geometric pattern is preferably achieved by placing them on a high-purity copper plate and floating them on a fluid film of pure water on the plate. The water film is then allowed to evaporate, and a wax is poured over the frustules on the plate, preferably a wax having a low enough viscosity that it will flow into the pores in the frustules. The wax-frustule film is then preferably spread to provide a relatively thin (ideally one frustule-thick) layer on the copper plate.

A “nanoindenter,” for example the Nano Indenter® XP available from MTS Systems Corporation of Eden Prairie, Minn., is then preferably used to manipulate the frustules into the desired pattern. In a preferred embodiment, manipulation of the frustules is microprocessor controlled, according to a software algorithm. Rather than using a “nanoindenter,” a visible manual manipulator may be constructed having, preferably, a sharp tip with a radius less than about 50 nanometers. The manipulator may be attached to an optical microscope, and engaged with frustules on the copper plate. Either the manipulator or the plate may be moved to slide the frustules one at a time into the desired position.

Once the frustules are appropriately arranged on the copper plate and embedded in wax, the plate is preferably immersed in dehydrated ethyl alcohol, and maintained therein until the wax around the frustules at least partially dissolves. An electrically conductive polymer, as described herein, is preferably placed over the arranged frustule layer. Due to surface tension, wax will typically dissolve at a faster rate around the frustules than inside the frustule pores. It is desirable for some wax to remain in the frustule pores to minimize covering over of the pores by the electrically conductive polymer. This is believed to be effective at least in part because the wax is a relatively electrically insulative material, thus making the regions of the pores more electrically resistive than regions around the frustules, and therefore more resistive to deposition of the electrically conductive polymer. Moreover, minimizing intrusion of the dehydrated ethyl alcohol into the pore regions further increases the difference in electrical resistivity of the pore regions relative to regions around the frustules, as ethyl alcohol will remain in those regions. To further increase the electrical resistance of the frustules, they may be exposed to distilled, deionized water prior to introduction of the polymer.

Further control over polymer deposition, i.e. avoiding covering over of the pores, may be achieved by controlling the voltage for depositing the polymer. A voltage may be applied to the system (the copper plate) at a level sufficient to trigger polymer deposition around the frustules, but insufficient to trigger polymer deposition on and within the frustules, due to the resistance imparted by the wax and water content of the frustules, in particular within their pores. This target voltage range will vary based on the particular diatom species, and is best determined by an iterative process. Where polymer is deposited on top of the frustules, it may be later removed with a laser. Local irregularities in polymer thickness may result from slight, difficult to control local variations in voltage drop across the copper plate. The placement and voltage of the power source(s) can be adjusted to maximize uniformity across the plate, in the polymer deposition step as well as the electroplating step, discussed below. An alternative means for depositing thin film materials for supporting the membrane matrix is disclosed in U.S. patent application Ser. No. 10/108,140 hereby incorporated by reference.

The copper plate and frustule-polymer structure is preferably next immersed in an electroplating solution. A metal film is deposited on top of the polymer, and generally conforms to the surface thereof, preferably in a thickness substantially equal to a diameter of the frustules. Once again, to discourage metal deposition on top of the frustules, the structure may be immersed in deionized water to provide for relatively greater electrical resistivity in the region of the frustule pores. After a sufficient amount of metal is deposited on the polymer layer, the polymer is burned or chemically removed, leaving a metallic membrane having the desired pore structures. Various metals may be used in the electroplating step, however, certain characteristics such as suitability for electroplating, interfacial properties with silica frustules, corrosion resistance and strength may make certain metals more desirable than others. To enhance the interfacial bond between frustules and the electroplated metal, the metal film is preferably deposited at a relatively high temperature. The high temperature is believed to assist in holding the frustules in the metal matrix by residual compressive stresses on the frustules. The deposition temperature is limited by the frustules' ability to maintain their chemical and structural integrity at elevated temperatures. Further enhancement of the interfacial strength may be achieved by providing a bending force on the metal-frustule layer as it is forming, resulting in residual compressive forces holding the frustules in position with the metal when the bending force is relaxed. Further enhancement of the interfacial strength between the frustules and the metal layer may be achieved by roughening the exteriors of the frustules with a suitable etching compound, such as hydrofluoric acid, prior to depositing the polymer and metal film.

Where overplating occurs, i.e. where too much metal is deposited, a process known as “reverse micro-electroplating” may be used to remove metallic material from the structure. The process preferably includes using a visible electrode that can be placed into pores in the frustules, and metallic material removed electrochemically.

Zeolite-Based Selective Molecular Screens

Zeolites provide an alternative source of porous silicaceous material suitable for constructing selective membranes in accordance with the present invention. Zeolites are microporous crystalline solids with well-defined structures. Generally, they contain silicon, aluminum and oxygen in their framework. A defining feature of a zeolite framework is that it is typically made up of 4-connected atoms. Zeolites are both naturally occurring, and synthetic. FIG. 5 illustrates gas flow through a mixed matrix zeolite-based membrane suitable for use with the present invention. Broadly, the zeolites, by virtue of the relatively small spatial separation of their constituent atoms selectively pass relatively small molecules. Thus, selectivity for the smallest molecules, i.e. hydrogen, is maximized in zeolites having relatively small distances between their constituent atoms. Other materials, for example, the polyimide described herein, are preferably incorporated into the zeolite membrane to further enhance the selectivity. Thus, while a preferred zeolite-polymer combination is disclosed, alternative zeolites, both naturally occurring and synthetic, and alternative polymers might be utilized to fabricate a membrane having the desired characteristics. The membranes may be fabricated, for example, from a polyamide and modified zeolite. The zeolites are preferably functionalized with amine groups by reacting them with aminopropyltrimethoxysilane in toluene. Membranes may then be successfully fabricated, for example, at about 20% weight zeolite and about 50% weight zeolite. The amine-tethered zeolites are believed to interact through secondary forces with carboxylic groups along the polymer backbone These interactions are believed to promote adhesion between the two components, desirable for achieving optimal selectivity of the membrane.

In a preferred embodiment, the polymeric material preferably includes a glassy polyimide, 6FDA-FpDA-DABA, and the preferred zeolite is a modified zeolite. A suitable process for membrane fabrication is disclosed in greater detail in the journal article by T. W. Pechar et al. published in Desalination 146 (2002) 3-9, the teachings of which are hereby incorporated by reference. The preferred polyimide is selected in part because attractive molecular forces exist between the polymer and the modified zeolites, enhancing adhesion there between. Moreover, the disclosed preferred polyimide exhibits good thermal stability, is soluble in common solvents and therefore easy to process, and provides good gas separation performance. Alternative polymers might be used in constructing the mixed matrix membrane, so long as such polymers have suitable physical and chemical properties. The preferred polyimide has the following structure and repeat unit:

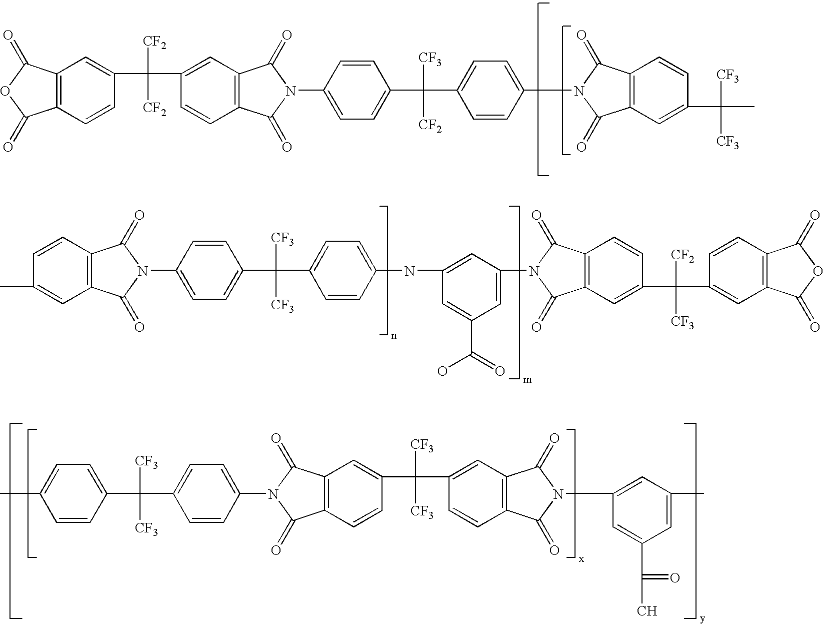

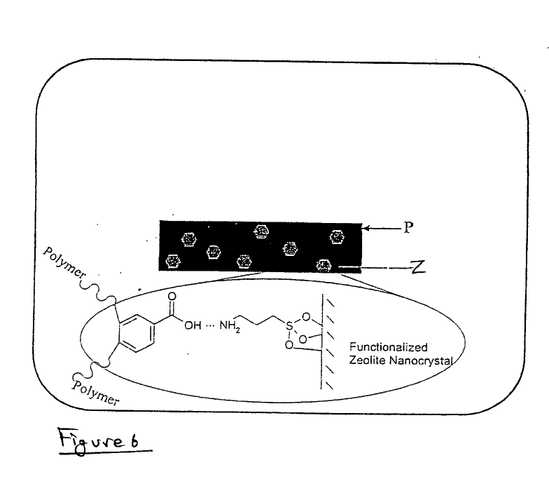

The preferred fabrication process relies upon the hydrogen bonding interaction between amine-terminated silane coupling agents that are tethered onto zeolite surfaces, and acidic groups incorporated into the polyimide backbone. This interaction is shown schematically in FIG. 6, wherein an amino-carboxylic acid interaction promotes adhesion between the zeolite and polymer via an acid-base interaction between —OH and —NH₂. “P” represents the polymer, whereas “Z” represents the modified zeolite. The preferred imide polymer is based on, for example, 75 mol % 4,4′-hexaflouroisopropylidene dianiline (6FpDA) and 25 mol % iaminobenzoic acid (DABA) and has a weight average molecular weight 93,000 g/mol. Synthesis of the preferred polyimide is described, for example, in C. J. Cornelius, Ph.D. Dissertation, Virginia Polytechnic Institute and State University, 2000, publicly available and incorporated by reference herein.

The preferred zeolite may be synthesized as described in V. Nikolakis, G. Zomeritakes, A. Abibi, M. Dickson, M. Tsapatsis and D. G. Vlachos, J. Membr. Sci., 184 (2001) 209, the teachings of which are incorporated by reference herein. The zeolite described in the referenced article, ZSM-2, is regarded as a faujasite-type zeolite. The structure of ZSM-2 contains both Si and Al; therefore, extra framework cations such as Li are present to balance the charge of the anionic framework. The ZSM-2 crystals possess a hexagonal shape with the longest direction ˜250 nm, and a pore size of 0.74 nm. The framework density of faujasites is ˜1.31 g/cm³.

Once synthesized, the zeolites are preferably centrifuged and their aqueous solution replaced with toluene. The mixture is preferably added to a flask, and more toluene added to provide a zeolite concentration of about 6.2 mg/ml toluene. Aminopropyltriethoxysiliane (APTES) is then preferably added such that a ratio of 0.08 ml APTES/ ml toluene is present in the flask before the reaction. The mixture is then preferably refluxed under an Argon purge for approximately 2 h. Upon completion of the reaction, the mixture is preferably centrifuged several times, each time replacing the solvent with tetrahydrofuran (THF). An amount of 6FDA-6FpDA-DABA required to produce a 20% weight ZSM-2, 80% weight polyimide mixed matrix membrane (MMM) is then added to the zeolite-THF mixture and allowed to mix for 24 h. The solution may then be cast onto a surface coated with a relatively low friction material, such as polytetrafluoro-etshylene, and allowed to evaporate.

Sedimentation of ZSM-2 occurs during the membrane fabrication, presumably process as a result of the difference in the densities between THF (D=0.886 g/cm3) and ZSM-2 (D=1.31 g/cm3). As the zeolites sediment, many of them appear to have a preference to orient themselves such that their largest face (i.e., hexagonal face) becomes parallel to the membrane surface. This orientation results in the largest ZSM-2 face being positioned orthogonal to the gas flux, and provides more zeolite surface area for the gas molecules to encounter. This may be due to the hydrodynamic radius of the large zeolite. This orientation is believed to yield better separation performance than the same membrane without the zeolite orientation. Annealing the membranes is believed to further improve their performance.

The above-described process can be used to fabricate zeolite-based membranes suitable for use with the present invention. A particular advantage is that the membrane effectively separates hydrogen at room temperature, with the aid of a blower to feed the gas mixture through the membrane.

Carbide-Derived Carbon-Based Membranes

Another suitable material to be used as a base for constructing the selective membranes described herein is known as “carbide-derived carbon.” Carbon may be extracted by several processes from metal carbides, and is useful in constructing membranes suitable for use with the present invention, in particular because of its ease of fabrication in large scale structures. In an industrial extraction process, the rigid metal carbide lattice is used as a template, and the metal is extracted layer by layer, allowing atomic-level control. Accordingly, the remaining carbon structure (ultimately used in the membrane) can be templated by the carbide structure. Additional structural modifications and control can be achieved by varying the process temperature, gas composition and other variables. The carbide derived carbon templates are a porous structure that can be utilized in a mixed reactant molecular membrane fuel cell according to the present invention. Moreover, the actual pore size can be tuned by controlling a chlorination temperature of a metal carbide. An exemplary process for producing a tuned pore size membrane is set forth in the article “Nanoporous Carbide-Derived Carbon With Tunable Pore Size”, Gogotsi et al., Nature: Materials, September 2003, pp. 591-594, published on the web at http://www.nature.com/cgi-taf/DynaPage.taf?file=/nmat/journal/v2/n9/index.html, and incorporated by reference herein.

Providing For Membrane Oxygen Affinity

Where a diatom based molecular screen is desired to be selective for oxygen permeability, a siloxylation process is preferably used, wherein siloxylation of the inner walls of the silica frustule pores provides for enhanced affinity for oxygen. Siloxylation in combination with pore size of the membrane will preferentially pass oxygen versus other gases, in particular nitrogen where ambient air is used as the oxidant supply. Processes for siloxylation of glass and cellulose to form oxygen-selective membranes are set forth in U.S. Pat. No. 6,372,020 to Hong et al., hereby incorporated by reference. Conventional semi-permeable oxygen-selective polymer films may also be employed independently or in conjunction with the molecular screen, which can serve as a support for such films. Additional suitable siloxylation techniques/compounds are set forth in U.S. Pat. No. 6,495,708 to Yang et al., also incorporated by reference.

Oxygen Selective Membranes

Alternative embodiments are contemplated for the disclosed mixed reactant design wherein known oxygen-selective membranes are utilized to separate oxygen from the fluid stream of mixed reactants. In particular, the preferred membranes are operable at room temperature and atmospheric pressure, formed from perovskitic or multi-phase structures, having a chemically active coating, and are relatively thin, having a thickness preferably from .01 mm to 10 mm. Suitable membranes are known from U.S. Pat. No. 6,544,404 to Mazanec et al., incorporated by reference herein

Providing For Membrane Hydrogen Affinity

Where the diatom based molecular screen is desired to be selective for hydrogen permeability, steps similar to those set forth above are followed, however, proton-conductive fluids can further be applied to the molecular screen and held in the pores via capillary forces. Liquid concentrated phosphoric acid or another highly protic solvent may be utilized for this purpose, or some other material that is effective at transporting protons, so long as it does not substantially dissolve or interfere with the structure of the silica frustules, or the metal matrix. For example, hydrofluoric acid, though a protic solvent, would be unsuitable as it is known to etch silica-based materials. A silica layer may also be deposited on top of the frustules to provide for or enhance hydrogen affinity, for example, via the process set forth in U.S. Pat. No. 6,527,833 to Oyama, also incorporated by reference herein. The additional silica layer may be utilized alone or in combination with concentrated phosphoric acid, as described herein. Still further embodiments are contemplated in which the Oyama process is used to construct a stand-alone membrane for screening out hydrogen from a mixed reactant stream.

Hydrogen-Selective Membranes

Alternative embodiments are contemplated in which known hydrogen-selective membranes are used to separate hydrogen from the mixed reactant stream. In such designs, the hydrogen-selective membranes and processes set forth in U.S. Pat. Nos. 5,451,386 to Collins et al. and 6,569,226 to Dorris et al., hereby incorporated by reference, may be used. Dorris '226 is particularly preferred due to its suitability for operation at relatively low temperature and pressure, increased permeability with increased moisture content of the hydrogen-laden feedstock, and resistance to carbon monoxide and carbon dioxide poisoning. Further suitable hydrogen selective membranes are available from Noritake Co. and Chuden Electric Co. of Chubu, Japan.

Combination Electrode/Molecular Screen Embodiments

Alternative embodiments are contemplated wherein the molecular screen actually serves as the electrode itself. In such a design, utilizing for example the above-described diatom-based membrane, the electrically conductive metal that is electroplated onto the frustule/polymer layer can be connected to the fuel cell system's electrical circuit, and thus serve as either the anode or cathode. Further still, the molecular screen may be fashioned from a conductive catalytic material or coated with a suitable material to selectively catalyze the oxidation or reduction reaction in the system.

Fuel-Enriched Mixed Reactant Stream

In a further broad aspect, the present invention provides several different apparatuses and processes whereby a mixed reactant stream is provided through enrichment of air with a gaseous fuel. The fuel-enriched mixed reactant stream is preferably fed to a mixed reactant molecular screen fuel cell similar to the foregoing embodiments, for the production of electrical power. Alternatively, the fuel-enriched stream may be fed to known hydrogen and/or oxygen selective membranes, as described herein.

Mixed Reactant Molecular Screen Fuel Cell Utilizing a Water Split Reaction to Provide Hydrogen

Turning to yet another embodiment of the present invention, a mixed reactant molecular screen fuel cell using a water split reaction to provide a mixed reactant stream is disclosed. Broadly, the invention relates to the formation of a hydrogen-enriched mixed reactant stream that preferably combines hydrogen from an electrochemical or photolytic source with ambient air. The reactants are then preferably provided to a mixed reactant molecular screen fuel cell in accordance with other aforementioned embodiments of the present invention. This aspect of the present invention is contemplated for particular use with electric powered heavy machinery, or other systems drawing a relatively large electric load in operation. The wide, often free availability of water for use in fuel cells according to the present invention allows fuel cell-driven machines to be operated relatively inexpensively.

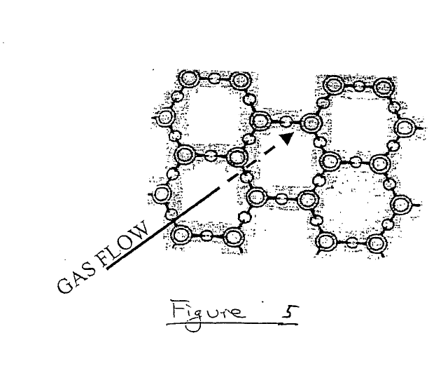

One particularly preferred hydrogen production process is disclosed in U.S. Pat. No. 6,582,676, hereby incorporated by reference. FIG. 4 illustrates an exemplary proton exchange membrane fuel cell apparatus 100 including an aluminum catalyst system 170 suitable for adaptation for a mixed reactant molecular screen fuel cell 110 according to the present invention. The '676 patent is directed to a system wherein a metal catalyst, containing aluminum, is used to split water into hydrogen and oxygen. The aluminum catalyst forms aluminum hydroxide in a water bath, while free hydrogen is liberated, suitable for mixing with ambient air to provide the mixed reactant stream for use in the present invention. In apparatus 100, a mixed reactant supply line 172 is provided for delivering a stream of mixed reactants to fuel cell 110.

In a preferred embodiment of the present invention, a water tank is provided proximate to the fuel cell that powers electrical machinery or other electrical devices. The catalyst is provided in a form suitable for incremental introduction into the water tank to provide a regulated supply of hydrogen on an as needed basis based on the demand for electricity required by the fuel cell application. For example, the catalyst quantity in the water tank at any one time can be adjusted to accommodate varying electrical loads providing a regulated fuel supply of hydrogen. Passivated catalyst can be reground for further use, removing a fully reacted exterior layer from the catalyst particles or pellets, and exposing un-reacted catalyst surface for further use. A particularly preferred (not shown) embodiment utilizes a removable screen cartridge that holds fresh and spent catalyst, and separates the same from the rest of the water tank. As illustrated in FIG. 4, the storage tank preferably includes a water connection 171 so that the storage tank 173 can be refilled with water, and an outlet 174 to allow reactants to flow to the subject fuel cell 110. Air can be mixed with the generated hydrogen in the storage tank itself, or downstream thereof. Various means can be used for supplying a desired amount of air to the hydrogen stream, for instance impellers, pumps, or venturis. Further embodiments are contemplated wherein a screw feed, carousel, rotatable basket or similar device is used to provide catalyst from a dry environment to the water tank upon demand.

In another preferred embodiment (not shown), the water and catalyst are provided in the form of a removable cartridge, similar to a battery, particularly for use with smaller electrical devices such as personal computers.

Mixed Reactant Molecular Screen Fuel Cell Utilizing Water-Gas Shift Reaction For Hydrogen Production

In another preferred embodiment (not shown), carbon monoxide and water vapor are used to generate hydrogen. Carbon monoxide and water are reacted in the presence of a relatively small amount of nano-crystalline gold or platinum-cerium catalyst to form carbon dioxide and hydrogen gas. An exemplary process and compositions are described in the article entitled “Active Nonmetallic Au and Pt Species on Ceria-Based Water-Gas Shift Catalysts” published Aug. 15, 2003 in Science Vol. 301, the teachings of which are hereby incorporated by reference.

In this embodiment, hydrogen is produced and mixed with air to provide a mixed reactant stream for powering a mixed reactant molecular screen fuel cell, as described herein. In a preferred embodiment, a reactor (not shown) is provided and mounted onboard a fuel cell vehicle or modular fuel cell. The particular preferred apparatus is similar to those described with respect to other embodiments of the invention described herein.

Mixed Reactant Molecular Screen Fuel Cell Utilizing Bacterial Enzymes Such as Hydrogenase to Provide a Hydrogen-Enriched Mixed Reactant Stream

Still further embodiments are contemplated wherein enzymes, in particular, water-soluble enzymes derived from hydrogen-generating bacteria are used to form hydrogen from aqueous acids. In a preferred embodiment, similar to the above-described embodiment utilizing the water split reaction, a water tank is mounted proximate a fuel cell system according to the present invention, and a mixed reactant stream of air and hydrogen produced and delivered to the fuel cell. Exemplary enzymes and a process for their production are described at http://www.nature.con/nsu/011011/011011-3.html, the teachings of which are hereby incorporated by reference.

Allan: Please provide a publication cite for the above, if possible, as I could not find one.

Mixed Reactant Molecular Screen Fuel Cell Additionally Utilizing Selective Production of Orthohydrogen or Parahydrogen

Yet another preferred embodiment of the present invention utilizes an alternative apparatus for producing hydrogen from water. FIG. 4 further illustrates an apparatus wherein an electrode apparatus 112 is placed in a water tank 111, and thereby utilized to electrolyze water into hydrogen and oxygen. The mixed reactant stream is fed via a valved supply line 120 to fuel cell 110. A suitable electrode design and operation are disclosed in particularity in U.S. Pat. No. 6,126,794 to Chambers, hereby incorporated by reference.

Conventional electrolysis cells are capable of producing hydrogen and oxygen from water. These conventional cells include two electrodes within the cell that apply electrical energy to water to produce hydrogen and oxygen. The electrodes are typically made from two different materials. Different types of hydrogen are known, including parahydrogen and orthohydrogen. Orthohydrogen is a form of hydrogen wherein the nuclei of the two constituent hydrogen atoms have parallel spins, whereas in parahydrogen the nuclei have opposing spins. Orthohydrogen is typically produced predominantly in electrolytic cells, and is more combustible than parahydrogen. Parahydrogen tends to be difficult and expensive to make.

It is desirable to produce significant quantities of hydrogen and oxygen from ordinary tap water, without a chemical catalyst and without the input of excessive electrical power. The hydrogen, preferably predominantly parahydrogen, can then be supplied to a mixed reactant molecular screen fuel cell, as shown in FIG. 4. In alternative embodiments, the hydrogen and oxygen produced in the reaction can be separated by molecular screens constructed according to the present invention, and the substantially pure oxygen and hydrogen supplied to the anode and cathode, respectively, of a conventional fuel cell. In one particularly preferred embodiment, the parahydrogen/orthohydrogen proportion can be varied, as described in U.S. Pat. No. 6,126,794, to provide for relatively slower or faster reacting hydrogen in the mixed reactant stream. It is contemplated that in applications wherein the mixed reactant oxygen and hydrogen stream must be supplied over a relatively greater distance, e.g. via long supply lines or via storage tanks, relatively less reactive parahydrogen should be in greatest abundance, to minimize the reactance of the fuel and oxidizer prior to introduction to the fuel cell. Where the mixed reactants are produced substantially adjacent the molecular screens, it may be unnecessary to produce such a high proportion of parahydrogen. The system becomes self pressurized due to the production of gaseous oxygen and hydrogen from water, and it is therefore unnecessary to provide a supplemental pressurization system to ensure that sufficient reactants are transferred via the molecular screens to the electrodes (or that sufficient reactants pass through the molecular screens where the screens themselves serve as the electrodes).

Combination Catalyzed Electrolytic and Non-Catalyzed Electrolytic Fuel Cells

In yet another embodiment of the present invention, also illustrated in FIG. 4, a reaction vessel and water tank 173 utilizing the above described aluminum catalyst-driven hydrolysis reaction (U.S. Pat. No. 6,582,676) can be mounted in combination with a non-catalyst system 112/111 such as that described in U.S. Pat. No. 6,126,794. Where both systems are employed in the same electricity generating apparatus, a fail safe condition is created, allowing the continued generation of hydrogen gas via the catalyst driven hydrolysis if the electrically driven hydrolysis fails.

Continuous Loop Water Supply Fuel Cell Apparatus

Yet another broad aspect of the present invention is also illustrated in FIG. 4. The apparatus preferably includes a continuous loop apparatus wherein water reformed upon reduction of hydrogen is re-circulated to the water tanks for reuse via a return line 121. This provides for a closed loop, and can significantly enhance the range of a vehicle powered by a fuel cell system according to the present invention.

Mixed Reactant Molecular Screen Fuel Cell in Conjunction with Hydrogen Storing Materials

Various alternative embodiments are contemplated wherein hydrogen is provided for a mixed reactant stream from a source of stored hydrogen. For example, U.S. Pat. No. 6,193,929, incorporated by reference herein, discloses a hydrogen storage alloy that may be substituted for the above described hydrogen generation systems. Similarly, U.S. Pat. No. 6,589,312, also incorporated by reference herein, discloses nanoparticles for hydrogen storage, transportation and distribution, which are suitable for use in conjunction with the present invention to provide a hydrogen-enriched mixed reactant stream.

Fuel Cell Propulsion Drive With Supercapacitor Bank and Water Split Reaction Hydrogen Source

Referring to FIG. 3, there is shown a system level diagram illustrating schematically a fuel cell propulsion drive 200 according to yet another embodiment of the present invention. In the FIG. 3 embodiment, four exemplary electric drive motors 221 and controllers 223 are shown electrically connected with a mixed reactant molecular screen fuel cell 210 according to the present invention. A water tank 211 containing, for example, a water split reaction catalyst as described herein is provided and operable to combine hydrogen with an air stream for supplying fuel cell 210 with mixed reactants. It should be appreciated that the presently described design is not limited to the use of a water split reaction supply of hydrogen. Other hydrogen sources such as radiolytic, photolytic, bottled hydrogen, hydrocarbon sources, etc. might be used without departing from the scope of the present invention.

Fuel cell propulsion drive 200 further preferably includes a supercapacitor bank, labeled 212. Supercapacitor bank 212 is preferably utilized to store electrical charge or power that can be controllably delivered to system 200 during times of particularly high power load, for example during vehicle acceleration. Supercapacitors are known in the art from, for example, U.S. Pat. No. 6,602,742 and United States Patent Application Publication Nos. 2002/0097549, 2003/0064565, 2003/0172509, all of which are incorporated by reference herein. The supercapacitor bank 212 provides for “load leveling” of system 200, such that extra electrical power, stored in the form of electrical charge, in the supercapacitor bank can be provided as needed. When the power demands on system 200 are more moderate, excess electrical power produced, for example, from hydrogen generated in the onboard water split reaction system, can be utilized to recharge the bank 212.

Fuel Cell Drive Wherein Vehicle Forward Motion Provides Gas Pressure Drive for Fuel and Oxidant Mixture Delivery

It is contemplated that the mixed reactant stream will be delivered to the fuel cell in part with air pressure created by translation of the vehicle. For example, an inlet can be provided in the front of the vehicle into which air may be forced as the vehicle travels forward. Thus, with increasing vehicle speed the air pressure available for driving the mixed reactant streams to the fuel cell molecular screens increases.

### Industrial Applicability

The present invention eliminates the risk of explosions by using the molecular screen to transport hydrogen from a mixed reactant stream across the boundaries of the cell. The need to refuel the fuel cell with explosive containerized hydrogen gas is completely eliminated. The hydrogen is consumed as fast as it is required from the mixed reactant mixture source. Further, the present invention eliminates the need for a hydrogen delivery and storage infrastructure to be created to refuel hydrogen-powered vehicles. Lack of infrastructure has heretofore been recognized as a major obstacle to overcome in converting from combustible sources such as gasoline to a hydrogen fuel source. There is further no need to store fuel in large reservoirs and then transfer the fuel to the fuel cell, nor the requirement of onboard reformers or other hydrogen-producing apparatuses. Further still, in earlier designs electrochemical reaction only occurs at sites on the catalyst where reactant and electrolyte meet together.

The present invention overcomes this problem by being highly selective to the fuel delivered to the anode, as well as the oxidant delivered to the cathode of the fuel cell. Minimal parasitic fuel oxidant reduction occurs as a result of the extremely high selectivity of the molecular screen at the anode and cathode. The molecular screen can also be loaded with catalysts to aid in the catalytic reaction with the fuel.

Further still, by selecting the appropriate selective electrode materials and electrolyte, the present invention may operate at room temperature. Using appropriate electrodes and electrolytes in conjunction with either of the above diatom or zeolite-based membranes means that the challenges associated with sealing and supporting high temperature reactions are largely overcome. In addition, the relatively complex thermal management systems associated with many hydrogen separation membranes are eliminated. Moreover, the energy lost as radiating heat in the present designs is substantially reduced.

Most current hydrogen separation membranes, for example, palladium silver, ceramic palladium, and ceramic silicates, operate in the 350 to 800 degree Celsius range. There is an enormous difference between operation at ambient temperatures, as in the presently disclosed designs, and operation at such highly elevated temperatures, creating substantial advantages in terms of start-up energy required for an electric vehicle.

Further embodiments may utilize Non-faradaic Electrochemical Modification of Catalytic Activity (NEMCA) or similar effects to enhance the stability of the mixture when the device is not generating electricity. The NEMCA effect is a recognition that the activity of an electrocatalyst may be modified by its surface charge. Thus, altering the surface charge of the electrodes and/or catalyst (whether separate from the electrodes or the electrode itself) can alter their catalytic activity.

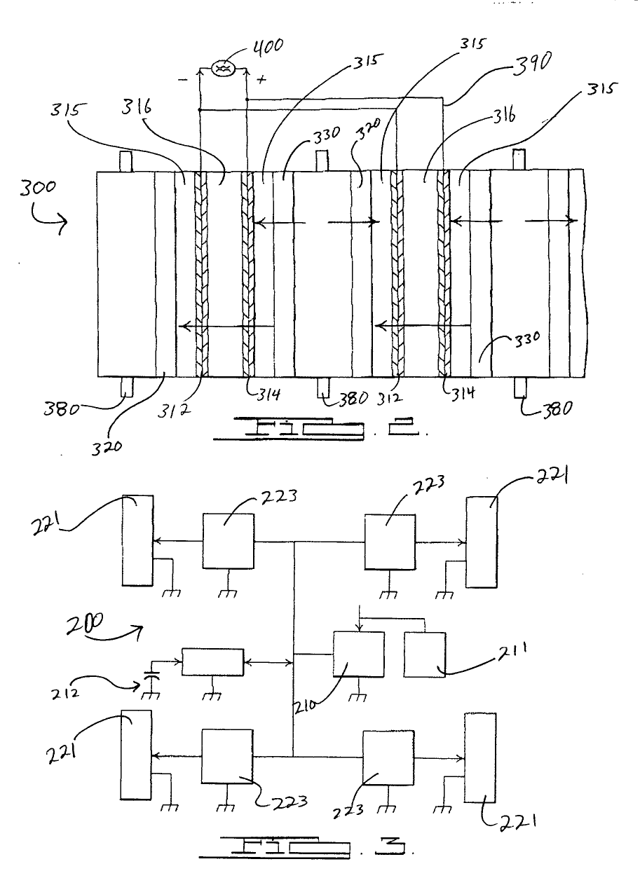

The single cell heretofore described may be adapted to a fuel cell stack arrangement, for example a stack of electrodes connected in series or parallel. Referring to FIG. 2, there is shown one exemplary fuel cell repeating stack structure 300 comprising a plurality of electrodes 3 of alternating polarity connected in parallel.

A single stable supply of mixed reactants in a combination of miscible/immiscible fluids might be used in conjunction with the present invention. In such a design, turbulence may be induced in the system to enhance the contact between the immiscible or partially immiscible phases. The system may also include a supply of reactants containing a component capable of disproportionation. For example, the reactant may include carbon monoxide, which disproportionates to carbon and carbon dioxide, which can be regenerated to carbon monoxide by heating. Another example is a solution of manganese ions, in which the disproportionating component is also the electrolyte. Still further embodiments are contemplated wherein liquid carriers are utilized to dissolve oxygen for transfer across the molecular screen.

In the FIG. 2 embodiment, a mixed reactant stream enters system 300 preferably via a plurality of inlets 380. A plurality of oxidant selective molecular screens 320 are positioned such that oxidant from the reactant stream may selectively pass there through. A gas diffusion space 315 preferably separates the oxidant selective screens each from a cathode 312. An impermeable electrolyte 316 is in turn positioned adjacent the cathodes 312. Anodes 314, gas diffusion spaces 315, and fuel selective molecular screens 330, respectively, are positioned on the opposite side of each electrode 316. A power loop 390 connects the parallel arranged electrode circuits with an electrical device such as a motor 400. System 300 preferably incorporates the mixed reactant molecular screen structure of FIG. 1 into a repeating fuel cell stack arrangement. Thus, those skilled in the art will appreciate that all of the alternative designs, materials, etc. discussed herein are similarly applicable to the fuel cell design of system 300.

The present description is for illustrative purposes only, and should not be construed to limit the breadth of the present invention in any way. Thus, those skilled in the art will appreciate that various modifications might be made to the presently disclosed embodiments without departing from the spirit and scope of the present invention. Other aspects, features and advantages will be apparent upon an examination of the attached drawing.

1. An electrically powered apparatus comprising:
at least one electrical device connected to an anode and a cathode, said anode and cathode being fluidly isolated from one another;
a reactant supply system operable to provide a mixture of an oxidant and a fuel; and
an electricity generating cell connected with said supply system, said cell including a first membrane selectively permeable to said fuel and operably associated with said anode, a second membrane selectively permeable to said oxidant and operably associated with said cathode, and an electrolyte disposed between said first and second membranes.

2. The device of claim 1 comprising a power stack having a plurality of membranes selectively permeable to said fuel, and a plurality of membranes selectively permeable to said oxidant.

3. The device of claim 2 comprising a catalyst for oxidizing fuel at said anode.

4. The device of claim 3 wherein said catalyst is a first catalyst, and further comprising a second catalyst for reducing oxygen at said cathode.

5. The device of claim 3 wherein at least one of said first and second membranes comprises an electrical conductor.

6. The device of claim 5 wherein at least one of said first and second membranes includes the operably associated anode or cathode, respectively.

7. The device of claim 5 wherein at least one of said first and second membranes includes said first or said second catalyst, respectively.

8. The device of claim 7 wherein at least one of said first and second membranes comprises a silica-based matrix.

9. The device of claim 2 comprising
a first selective catalyst disposed between said first membrane and said electrolyte for oxidizing fuel at said anode;
a second selective catalyst disposed between said second membrane and said electrolyte for reducing oxidant at said cathode.

10. The device of claim 2 comprising an on-board fuel-enrichment apparatus operable to provide a fuel to said supply system.

11. The device of claim 10 wherein said fuel-enrichment apparatus comprises a hydrolytic system.

12. The device of claim 11 comprising an electrolytic system operable to selectively produce a first fuel type and a second fuel type.

13. An electricity generating cell comprising:
a reactant supply operable to provide a mixture of an oxidant and a fuel;
a power circuit configured to drive an electrical load and including an anode and a cathode;
an electrolyte disposed between and fluidly isolating said anode and said cathode;
a selectively fuel-permeable membrane in communication with said reactant supply to provide fuel to said anode; and
a selectively oxidant-permeable membrane in communication with said reactant supply to provide oxidant to said cathode.

14. The electricity generating cell of claim 13 wherein at least one of said membranes comprises a silicon based matrix defining a plurality of pores.

15. The electricity generating cell of claim 14 wherein said silicon based matrix comprises a plurality of similar silica structures arranged in a predetermined geometric pattern.

16. The electricity generating cell of claim 15 wherein said selectively fuel-permeable membrane comprises a protic solvent disposed in said pores.

17. The electricity generating cell of claim 16 wherein said selectively oxidant-permeable membrane comprises high oxidant-affinity chemical modifiers attached to said silicon based matrix.

18. A method of electrochemically generating electricity in a device having a fluidly isolated anode and cathode and a power loop connecting the same, the method comprising the steps of:
providing a reactant stream that includes a fuel;
supplying fuel from the reactant stream to the anode by separating at least a portion of the fuel from the reactant stream with a selectively fuel-permeable membrane; and
supplying oxidant to the cathode.

19. The method of claim 18 wherein:
the step of providing a reactant stream comprises providing a reactant stream containing both oxidant and fuel; and
the step of supplying oxidant to the cathode includes separating at least a portion of the oxidant from the reactant stream with a selectively oxidant-permeable membrane.

20. The method of claim 19 wherein the step of providing a reactant stream comprises providing a fuel and oxidant mixture that can be substantially reacted in the device only with at least one of additional heat and a catalyst.
